(19) United States
(12) Patent Application Publication
(10) Pub. No.: US 2017/0278470 A1
(43) Pub. Date: Sep. 28, 2017

(54) DISPLAY DRIVING METHOD FOR A DISPLAY PANEL, DISPLAY DRIVING CIRCUIT AND DISPLAY DEVICE

(71) Applicants: Boe Technology Group Co., Ltd., Beijin (CN); BEIJING BOE OPTOELECTRONICS TECHNOLOGY CO., LTD., Beijin (CN)

(72) Inventor: Dan Su, Beijing (CN)

(21) Appl. No.: 15/503,054

(22) PCT Filed: Aug. 17, 2016
(86) PCT No.: PCT/CN2016/095685

§ 371 Date: Feb. 10, 2017

(30) Foreign Application Priority Data
Oct. 26, 2015 (CN) 201510702813.X

(51) Int. Cl. G09G 3/36; G09G 3/20; H04N 3/12; G09G 5/00

(52) U.S. Cl. CPC G09G 3/3614; G09G 5/006; G09G 3/20; G09G 3/3696; H04N 3/127; G09G 3/36; G09G 3/2011; G09G 2320/0276

(57) ABSTRACT

The present disclosure provides a display driving method for a display panel, comprising: calculating a difference value of display data; converting difference values as well as display data of rows in the display image of the current frame for which difference values are not calculated into gray scale voltages; increasing or decreasing a gray scale voltage corresponding to the difference value on a gray scale voltage corresponding to the display data of a corresponding row in the display image of the previous frame and outputting the obtained gray scale voltage to a respective data line; and outputting a gray scale voltage corresponding to the display data of the row in the display image of the current frame for which the difference value is not calculated to a respective data line. The present disclosure further provides a display driving circuit and a display device.

The present application is the U.S. national phase entry of PCT/CN2016/095685, with an international filing date of Aug. 17, 2016, which claims the benefit of Chinese Patent Application No. 201510702813.X, filed on Oct. 26, 2015, the entire disclosure of which is incorporated herein by reference.

### TECHNICAL FIELD

The present disclosure relates to the field of display technology, particularly to a display driving method for a display panel, a display driving circuit and a display device.

### BACKGROUND

In the existing display panels, the organic light emitting diode (OLED) display panel has advantages of simple manufacturing process, low cost, high light emitting efficiency and an easily formable flexible structure. The liquid crystal display panel (LCD) has advantages of low power consumption, high display quality, free of electromagnetic radiation and wide application scope. The organic light emitting diode display panel and the liquid crystal display panel are both important display panels at present.

In the process of displaying images (for example, text editing of images) by the existing display panel, the area of the region where the whole display image changes is very small. However, the driving circuit still performs analysis, conversion and transmission on the display data in the display image of each frame. That is to say, the driving circuit performs a large amount of repetitive work. This causes the display panel to consume a relatively high amount of power.

### SUMMARY

In view of this, embodiments of the present disclosure provide a display driving method for a display panel, a display driving circuit and a display device, for reducing power consumption of the display panel.

According to an aspect of the present disclosure, a display driving method for a display panel is provided, comprising:

calculating a difference value of display data of at least one row in a display image of a current frame relative to display data of a corresponding row in a display image of a previous frame;

converting difference values that are larger than zero and smaller than to zero in the calculated difference values, as well as display data of rows in the display image of the current frame for which difference values are not calculated into gray scale voltages;

when a gate scanning signal is loaded onto a gate line electrically connected with a pixel unit corresponding to a row in the display image of the current frame for which a difference value is calculated, increasing or decreasing a gray scale voltage corresponding to the difference value on a gray scale voltage corresponding to the display data of a corresponding row in the display image of the previous frame and outputting the obtained gray scale voltage to a respective data line;

when a gate scanning signal is loaded onto a gate line electrically connected with a pixel unit corresponding to a row in the display image of the current frame for which the difference value is not calculated, outputting a gray scale voltage corresponding to the display data of the row in the display image of the current frame for which the difference value is not calculated to a respective data line.

In one embodiment, calculating a difference value of display data of at least one row in a display image of a current frame relative to display data of a corresponding row in a display image of a previous frame comprises:

calculating a difference value of display data of at least one row in a display image of a current frame relative to display data of a corresponding row in a display image of a previous frame using a binary system.

In one embodiment, loading a gate scanning signal onto a gate line electrically connected with a pixel unit corresponding to each row in the display image of the current frame comprises:

loading a gate scanning signal onto the gate line twice successively.

In one embodiment, increasing or decreasing a gray scale voltage corresponding to the difference value on a gray scale voltage corresponding to the display data of a corresponding row in the display image of the previous frame and outputting the obtained gray scale voltage to a respective data line comprise:

increasing or decreasing a gray scale voltage corresponding to the difference value on a gray scale voltage corresponding to the display data of a corresponding row in the display image of the previous frame and outputting the obtained gray scale voltage to a respective data line under control of a polarity reversal input signal, a latch input signal and a difference polarity input signal.

In one embodiment, increasing or decreasing a gray scale voltage corresponding to the difference value on a gray scale voltage corresponding to the display data of a corresponding row in the display image of the previous frame and outputting the obtained gray scale voltage to a respective data line under control of a polarity reversal input signal, a latch input signal and a difference polarity input signal comprises:

when the calculated difference value is larger than zero, a polarity of the difference polarity input signal being positive, increasing a gray scale voltage corresponding to the difference value on a gray scale voltage corresponding to the display data of a corresponding row in the display image of the previous frame and outputting the obtained gray scale voltage to a respective data line under control of a polarity reversal input signal and a latch input signal;

when the calculated difference value is smaller than zero, a polraity of the difference polarity input signal being negative, decreasing a gray scale voltage corresponding to the difference value on a gray scale voltage corresponding to the display data of a corresponding row in the display image of the previous frame and outputting the obtained gray scale voltage to a respective data line under control of a polarity reversal input signal and a latch input signal.

According to another aspect of the present disclosure, a display driving circuit of a display panel is provided, comprising: a timing control circuit, a gate driving circuit and a source driving circuit.

The timing control circuit is used for calculating a difference value of display data of at least one row in a display image of a current frame relative to display data of a corresponding row in a display image of a previous frame.

The gate driving circuit is used for loading a gate scanning signal onto each gate line.

The source driving circuit is used for converting difference values that are larger than zero and smaller than zero in the calculated difference values, as well as display data of rows in the display image of the current frame for which difference values are not calculated into gray scale voltages; when a gate scanning signal is loaded onto a gate line electrically connected with a pixel unit corresponding to a row in the display image of the current frame for which a difference value is calculated, increasing or decreasing a gray scale voltage corresponding to the difference value on a gray scale voltage corresponding to the display data of a corresponding row in the display image of the previous frame and outputting the obtained gray scale voltage to a respective data line; when a gate scanning signal is loaded onto a gate line electrically connected with a pixel unit corresponding to a row in the display image of the current frame for which the difference value is not calculated, outputting a gray scale voltage corresponding to the display data of the row in the display image of the current frame for which the difference value is not calculated to a respective data line.

In one embodiment, the timing control circuit is used for calculating a difference value of display data of at least one row in a display image of a current frame relative to display data of a corresponding row in a display image of a previous frame using a binary system.

In one embodiment, the gate driving circuit is used for loading a gate scanning signal onto a gate line electrically connected with a pixel unit corresponding to each row in the display image of the current frame twice successively.

In one embodiment, the source driving circuit is used for increasing or decreasing a gray scale voltage corresponding to the difference value on a gray scale voltage corresponding to the display data of a corresponding row in the display image of the previous frame and outputting the obtained gray scale voltage to a respective data line under control of a polarity reversal input signal, a latch input signal and a difference polarity input signal.

In one embodiment, the source driving circuit is used for: when the calculated difference value is larger than zero, a polarity of the difference polarity input signal being positive, increasing a gray scale voltage corresponding to the difference value on a gray scale voltage corresponding to the display data of a corresponding row in the display image of the previous frame and outputting the obtained gray scale voltage to a respective data line under control of a polarity reversal input signal and a latch input signal; when the calculated difference value is smaller than zero, a polarity of the difference polarity input signal being negative, decreasing a gray scale voltage corresponding to the difference value on a gray scale voltage corresponding to the display data of a corresponding row in the display image of the previous frame and outputting the obtained gray scale voltage to a respective data line under control of a polarity reversal input signal and a latch input signal.

According to another aspect of the present disclosure, a display device is provided, comprising: a display driving circuit provided by any of the above embodiments.

In the display driving method for a display panel provided by embodiments of the present disclosure, a difference value of display data of at least one row in a display image of a current frame relative to display data of a corresponding row in a display image of a previous frame is calculated. When digital to analog conversion is performed, for rows in the display image of the current frame for which difference values are calculated relative to the display data of the corresponding rows in the display image of the previous frame, the digital to analog conversion is only performed on difference values that are larger than zero and smaller than zero in the calculated difference values. When a gate scanning signal is loaded onto a gate line electrically connected with a pixel unit corresponding to the row, a gray scale voltage corresponding to the difference value is increased or decreased on a gray scale voltage corresponding to the display data of a corresponding row in the display image of the previous frame and the obtained gray scale voltage is outputted to a respective data line. In this way, in the event that the display images of two adjacent frames are substantially not changed, repeated digital to analog conversion can be avoided, thereby reducing power consumption of the display panel.

### BRIEF DESCRIPTION OF THE DRAWINGS

FIGS. 1-3 are flow charts of a display driving method for a display panel provided by embodiments of the present disclosure respectively;

FIG. 4 is a timing diagram of a display driving method for a display panel provided by embodiments of the present disclosure; and

FIG. 5 is a schematic view of a display driving circuit of a display panel provided by embodiments of the present disclosure.

### DETAILED DESCRIPTION

Next, specific implementations of the display driving method for a display panel, the display driving circuit and the display device provided by embodiments of the present disclosure will be explained in detailed with reference to the drawings.

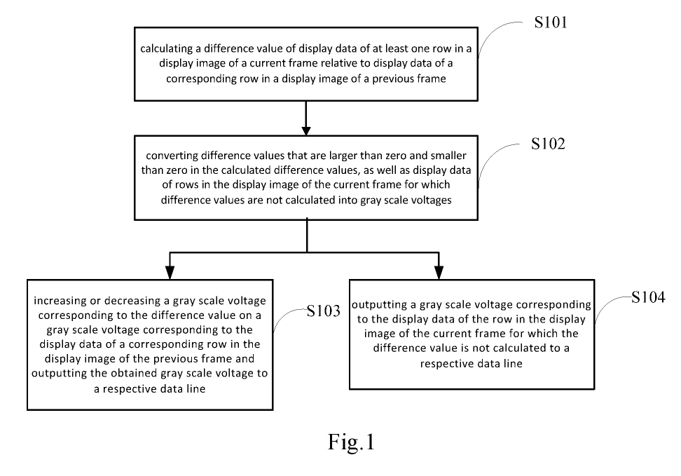

A display driving method for a display panel provided by embodiments of the present disclosure, as shown in FIG. 1, comprises the following steps.

S101, calculating a difference value of display data of at least one row in a display image of a current frame relative to display data of a corresponding row in a display image of a previous frame. The display image of the current frame does not comprise the display image of the first frame. For example, difference values of display data of rows in the display image of the second frame relative to display data of corresponding rows in the display image of the first frame are calculated.

S102, converting difference values that are larger than zero and smaller than zero in the calculated difference values, as well as display data of rows in the display image of the current frame for which difference values are not calculated into gray scale voltages. For example, the display data of rows in the display image of the first frame and the difference values that are larger than zero and smaller than zero of the display data of rows in the display image of the second frame relative to the display data of corresponding rows in the display image of the first frame are converted into gray scale voltages.

When a gate scanning signal is loaded onto a gate line electrically connected with a pixel unit corresponding to a row in the display image of the current frame for which a difference value is calculated, step S103 is performed. When a gate scanning signal is loaded onto a gate line electrically connected with a pixel unit corresponding to a row in the display image of the current frame for which a difference value is not calculated, step S104 is performed.

S103, increasing or decreasing a gray scale voltage corresponding to the difference value on a gray scale voltage corresponding to the display data of a corresponding row in the display image of the previous frame and outputting the obtained gray scale voltage to a respective data line. For example, within the time period of display of the second frame, when a gate scanning signal is loaded onto a respective gate line, a gray scale voltage corresponding to the difference value is increased or decreased on the gray scale voltage corresponding to the display data of a respective row in the display image of the first frame, and the obtained gray scale voltage is outputted to a respective data line.

S104, outputting a gray scale voltage corresponding to the display data of the row in the display image of the current frame for which the difference value is not calculated to a respective data line. For example, within the time period of display of the first frame, when a gate scanning signal is loaded onto a respective gate line, the gray scale voltage corresponding to the display data of a respective row in the display image of the first frame is outputted to a respective data line.

In the display driving method for a display panel provided by embodiments of the present disclosure, a difference value of display data of at least one row in a display image of a current frame relative to display data of a corresponding row in a display image of a previous frame is calculated. When digital to analog conversion is performed, for rows in the display image of the current frame for which difference values are calculated relative to the display data of the corresponding rows in the display image of the previous frame, the digital to analog conversion is only performed on difference values that are larger than zero and smaller than zero in the calculated difference values. When a gate scanning signal is loaded onto a gate line electrically connected with a pixel unit corresponding to the row, a gray scale voltage corresponding to the difference value is increased or decreased on a gray scale voltage corresponding to the display data of a corresponding row in the display image of the previous frame and the obtained gray scale voltage is outputted to a respective data line. In this way, in the event that the display images of two adjacent frames are substantially not changed, repeated digital to analog conversion can be avoided, thereby reducing power consumption of the display panel.

When the step S101, calculating a difference value of display data of at least one row in a display image of a current frame relative to display data of a corresponding row in a display image of a previous frame, in the display driving method provided by embodiments of the present disclosure is performed, as shown in FIG. 2, it can be implemented specifically in the following way.

S201, calculating a difference value of display data of at least one row in a display image of a current frame relative to display data of a corresponding row in a display image of a previous frame using a binary system. For example, take the 6 bit display driving manner as an example. Specifically, the display data of the first row in the display image of the first frame is 10101, and the display data of the first row in the display image of the second frame is 101101. In this case, the difference value of the display data of the first row in the display image of the second frame relative to the display data of the first row in the display image of the first frame is 000011.

In specific implementations, the display driving method provided by embodiments of the present disclosure is particularly suitable for splitting one frame of display image into two frames of display image that can be seen by the left eye and the right eye, so as to realize 3D display. When a gate scanning signal is loaded onto a gate line electrically connected with a pixel unit corresponding to each row in the display image of the current frame, the gate scanning signal can be loaded onto the gate line twice successively.

For example, in the process of loading gate scanning signals onto respective gate lines Gate1, Gate2, Gate3 . . . , firstly, two pulse signals are loaded onto the gate line Gate1, then two pulse signals are loaded onto the gate lines Gate2, and so on. After the respective gate lines Gate1, Gate2, Gate3 . . . are scanned, one frame of display image displayed by loading a first pulse signal onto respective gate line Gate1, Gate2, Gate3 . . . is seen by the left eye of a person, and one frame of display image displayed by loading a second pulse signal onto respective gate line Gate1, Gate2, Gate3 . . . is seen by the right eye of the person.

Certainly, the display driving method provided by embodiments of the present disclosure can also be suitable for 2D display. That is, when a gate scanning signal is loaded onto a gate line electrically connected with a pixel unit corresponding to each row in the display image of the current frame, a gate scanning signal is loaded onto the gate line once. For example, in the process of loading gate scanning signals onto respective gate lines Gate1, Gate2, Gate3 . . . , firstly, one pulse signal is loaded to the gate line Gate1, then one pulse signal is loaded onto the gate line Gate2, and so on. After the respective gate lines Gate1, Gate2, Gate3 . . . are scanned, the image displayed by loading pulse signals onto respective gate lines Gate1, Gate2, Gate3 . . . is a display image of one frame.

When the step S103, increasing or decreasing a gray scale voltage corresponding to the difference value on a gray scale voltage corresponding to the display data of a corresponding row in the display image of the previous frame and outputting the obtained gray scale voltage to a respective data line, in the display driving method provided by embodiments of the present disclosure is performed, as shown in FIG. 2, it can be implemented specifically in the following way.

S203, increasing or decreasing a gray scale voltage corresponding to the difference value on a gray scale voltage corresponding to the display data of a corresponding row in the display image of the previous frame and outputting the obtained gray scale voltage to a respective data line under control of a polarity reversal input signal, a latch input signal and a difference polarity input signal. The polarity of the difference polarity input signal depends on the polarity of the difference value. Specifically, when the difference value is positive, the polarity of the difference polarity input signal is positive, and a high level is outputted. Alternatively, when the difference value is negative, the polarity of the difference polarity input signal is negative, and a low level is outputted. For example, take the 6 bit display driving manner as an example. Specifically, the display data of the first row in the display image of the first frame is 101010, and the display data of the first row in the display image of the second frame is 101101. In this case, the difference value of the display data of the first row in the display image of the second frame relative to the display data of the first row in the display image of the first frame is 000011. This difference value is positive.

When the step 203, increasing or decreasing a gray scale voltage corresponding to the difference value on a gray scale voltage corresponding to the display data of a corresponding row in the display image of the previous frame and outputting the obtained gray scale voltage to a respective data line under control of a polarity reversal input signal, a latch input signal and a difference polarity input signal, in the display driving method provided by embodiments of the present disclosure is performed, as shown in FIG. 3, it can specifically comprise the following steps. That is, performing step S301 when the calculated difference value is larger than zero; and performing step S302 when the calculated difference value is smaller than zero.

S301, with a polarity of the difference polarity input signal positive, increasing a gray scale voltage corresponding to the difference value on a gray scale voltage corresponding to the display data of a corresponding row in the display image of the previous frame and outputting the obtained gray scale voltage to a respective data line under control of a polarity reversal input signal and a latch input signal.

S302, with a polarity of the difference polarity input signal negative, decreasing a gray scale voltage corresponding to the difference value on a gray scale voltage corresponding to the display data of a corresponding row in the display image of the previous frame and outputting the obtained gray scale voltage to a respective data line under control of a polarity reversal input signal and a latch input signal.

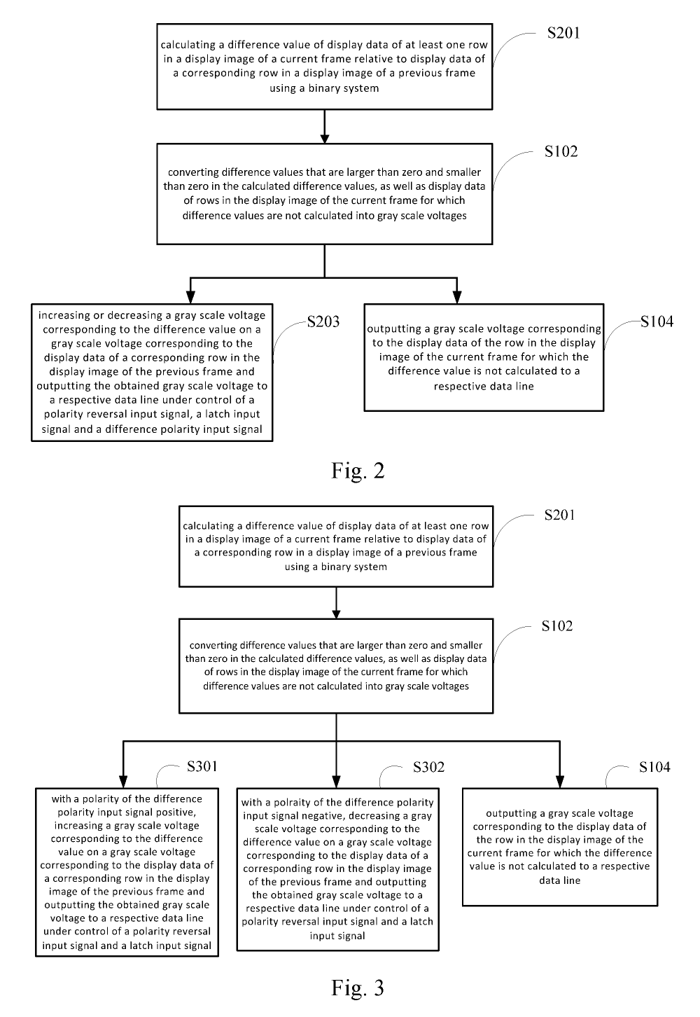

Specifically, in the driving timing diagram as shown in FIG. 4, two frames of display image seen by the left eye and the right eye are shown. Next, driving processes for the display image of the first frame and the display image of the second frame will be explained for example. Difference values of the display data of respective rows in the display image of the second frame relative to the display data of corresponding rows in the display image of the first frame are calculated. The display data of respective rows in the display image of the first frame and the difference values that are larger than zero and smaller than zero in the claculated difference values are converted into gray scale voltages. In the time period of display of the first frame, gate scanning signals are loaded onto respective gate lines Gate1, Gate2, Gate3 . . . under the control of the timing control signals CPV and OE1. The gray scale voltages corresponding to the display data of respective rows in the display image of the first frame are outputted to respective data lines under the control of the polarity reversal input signal POL and the latch input signal TP. In the time period of display of the second frame, gate scanning signals are loaded onto respective gate lines Gate1, Gate2, Gate3 . . . under the control of the timing control signals CPV and OE1. The gray scale voltages corresponding to the difference values are increased on the gray scale voltages corresponding to the display data of respective rows in the display image of the first frame and the obtained gray scale voltages are outputted to respective data lines under the control of the polarity reversal input signal POL, the latch input signal TP and the difference polarity input signal POLT (as shown in FIG. 4, when the gate line Gate2 is scanned, the difference value is positive, and the polarity of the POLT is positive). Alternatively, the gray scale voltages corresponding to the difference values are decreased on the gray scale voltages corresponding to the display data of respective rows in the display image of the first frame and the obtained gray scale voltages are outputted to respective data lines under the control of the polarity reversal input signal POL, the latch input signal TP and the difference polarity input signal POLT (as shown in FIG. 4, when the gate lines Gate1, Gate3 are scanned, the difference value is negative, and the polarity of the POLT is negative).

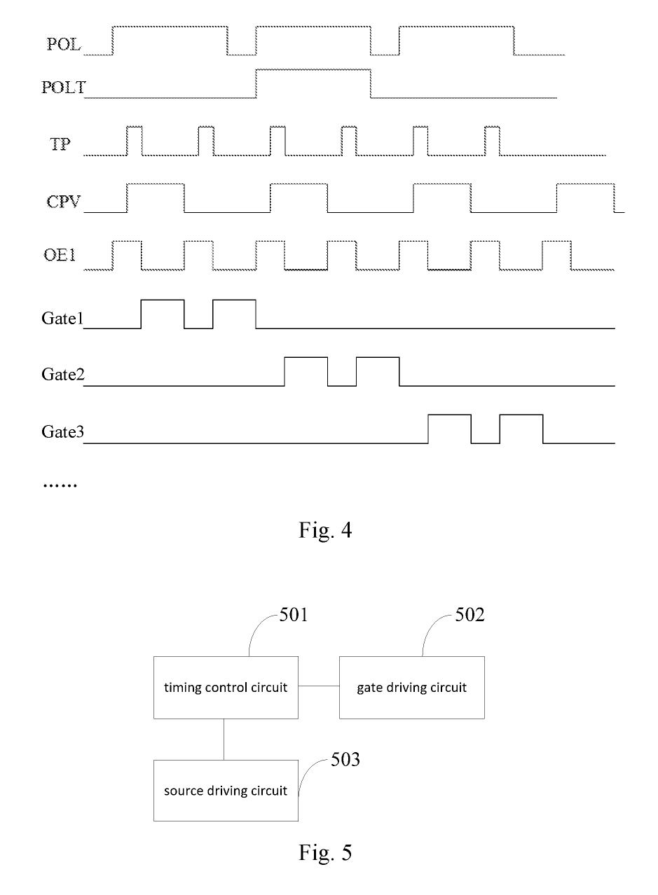

Based on the same inventive concept, embodiments of the present disclosure further provides a display driving circuit of a display panel. As shown in FIG. 5, The display driving circuit may comprise: a timing control circuit 501, a gate driving circuit 502 and a source driving circuit 503.

The timing control circuit 501 is used for calculating a difference value of display data of at least one row in a display image of a current frame relative to display data of a corresponding row in a display image of a previous frame. The display image of the current frame does not comprise the display image of the first frame. For example, difference values of the display data of respective rows in the display image of the second frame relative to the display data of corresponding rows in the display image of the first frame are calculated.

The gate driving circuit 502 is used for loading a gate scanning signal onto each gate line.

The source driving circuit 503 is used for converting difference values that are larger than zero and smaller than zero in the calculated difference values, as well as display data of rows in the display image of the current frame for which difference values are not calculated into gray scale voltages. When a gate scanning signal is loaded onto a gate line electrically connected with a pixel unit corresponding to a row in the display image of the current frame for which a difference value is calculated, a gray scale voltage corresponding to the difference value is increased or decreased on a gray scale voltage corresponding to the display data of a corresponding row in the display image of the previous frame and the obtained gray scale voltage is outputted to a respective data line. When a gate scanning signal is loaded onto a gate line electrically connected with a pixel unit corresponding to a row in the display image of the curent frame that for which difference value is not calculated, a gray scale voltage corresponding to the display data of the row in the display image of the current frame for which the difference value is not calculated is outputted to a respective data line.

The timing control circuit 501 can be used for calculating a difference value of display data of at least one row in a display image of a current frame relative to display data of a corresponding row in a display image of a previous frame using a binary system. For example, take the 6 bit display driving manner as an example. Specifically, the display data of the first row in the display image of the first frame is 101010, and the display data of the first row in the display image of the second frame is 101101. In this case, the difference value of the display data 101101 of the first row in the display image of the second frame relative to the display data 101010 of the first row in the display image of the first frame calculated by the timing control circuit 501 is 000011.

In specific implementations, the display driving circuit provided by embodiments of the present disclosure is particularly suitable for splitting one frame of display image into two frames of display image that can be seen by the left eye and the right eye, so as to realize 3D display. In the display driving circuit provided by embodiments of the present disclosure, the gate driving circuit 502 can be used for loading a gate scanning signal onto a gate line electrically connected with a pixel unit corresponding to each row in the display image of the current frame twice successively. For example, in the process of loading gate scanning signals onto respective gate lines Gate1, Gate2, Gate3 . . . by the gate driving circuit 502, firstly, the gate driving circuit 502 loads two pulse signals onto the gate line Gate1, then the gate driving circuit 502 loads two pulse signals onto the gate lines Gate2, and so on. After the gate driving circuit 502 scans the respective gate lines Gate1, Gate2, Gate3 . . . , one frame of display image displayed by loading a first pulse signal onto respective gate line Gate1, Gate2, Gate3 . . . by the gate driving circuit 502 is seen by the left eye of a person, and one frame of display image displayed by loading a second pulse signal onto respective gate line Gate1, Gate2, Gate3 . . . by the gate driving circuit 502 is seen by the right eye of the person.

Certainly, the display driving circuit provided by embodiments of the present disclosure can also be suitable for 2D display. That is, when the gate driving circuit 502 loads a gate scanning signal onto a gate line electrically connected with a pixel unit corresponding to each row in the display image of the current frame, the gate driving circuit 502 loads a gate scanning signal onto the gate line once. For example, in the process of loading gate scanning signals onto respective gate lines Gate1, Gate2, Gate3 . . . by the gate driving circuit 502, firstly, the gate driving circuit 502 loads one pulse signal onto the gate line Gate1, then the gate driving circuit 502 loads one pulse signal onto the gate line Gate2, and so on. After the respective gate lines Gate1, Gate2, Gate3 . . . are scanned, the image displayed by loading pulse signals onto respective gate lines Gate1, Gate2, Gate3 . . . is a display image of one frame.

The source driving circuit 503 can be used for increasing or decreasing a gray scale voltage corresponding to the difference value on a gray scale voltage corresponding to the display data of a corresponding row in the display image of the previous frame and outputting the obtained gray scale voltage to a respective data line under control of a polarity reversal input signal, a latch input signal and a difference polarity input signal. The polarity of the difference polarity input signal depends on the polarity of the difference value. Specifically, when the difference value is positive, the polarity of the difference polarity input signal is positive, and a high level is outputted. Alternatively, when the difference value is negative, the polarity of the difference polarity input signal is negative, and a low level is outputted. For example, take the 6 bit display driving manner as an example. Specifically, the display data of the first row in the display image of the first frame is 101010, and the display data of the first row in the display image of the second frame is 101101. In this case, the difference value of the display data of the first row in the display image of the second frame relative to the display data of the first row in the display image of the first frame is 000011. This difference value is positive.

The source driving circuit 503 can be used for: when the calculated difference value is larger than zero, a polarity of the difference polarity input signal being positive, increasing a gray scale voltage corresponding to the difference value on a gray scale voltage corresponding to the display data of a corresponding row in the display image of the previous frame and outputting the obtained gray scale voltage to a respective data line under control of a polarity reversal input signal and a latch input signal. Alternatively, when the calculated difference value is smaller than zero, a polarity of the difference polarity input signal being negative, decreasing a gray scale voltage corresponding to the difference value on a gray scale voltage corresponding to the display data of a corresponding row in the display image of the previous frame and outputting the obtained gray scale voltage to a respective data line under control of a polarity reversal input signal and a latch input signal.

It should be noted that implementations of the display driving circuit provided by embodiments of the present disclosure can make reference to embodiments of the display driving method, which will not be repeated.

Based on the same inventive concept, embodiments of the present disclosure further provides a display device, comprising the display driving circuit provided by embodiments of the present disclosure. The display device can be any product or component with a display function such as a mobile phone, a panel computer, a television, a display, a laptop, a digital photoframe, a navigator etc. Implementations of the display device can make reference to embodiments of the display driving circuit, which will not be repeated.

Apparently, the skilled person in the art can make various amendments and modifications to the embodiments of the present disclosure without departing from the spirit and the scope of the present disclosure. In this way, provided that these amendments and modifications of the present disclosure belong to the scopes of the Claims attached and the equivalent technologies thereof, the present disclosure also intends to encompass these amendments and modifications.

1. A display driving method for driving a display panel, comprising:
calculating a difference value of display data of at least one row in a display image of a current frame relative to display data of a corresponding row in a display image of a previous frame;
converting difference values that are larger than zero and smaller than zero in the calculated difference values, as well as display data of rows in the display image of the current frame for which difference values are not calculated into gray scale voltages;
when a gate scanning signal is loaded onto a gate line electrically connected with a pixel unit corresponding to a row in the display image of the current frame for which a difference value is calculated, increasing or decreasing a gray scale voltage corresponding to the difference value on a gray scale voltage corresponding to the display data of a corresponding row in the display image of the previous frame and outputting the obtained gray scale voltage to a respective data line; and
when a gate scanning signal is loaded onto a gate line electrically connected with a pixel unit corresponding to a row in the display image of the current frame for which the difference value is not calculated, outputting a gray scale voltage corresponding to the display data of the row in the display image of the current frame for which the difference value is not calculated to a respective data line.

2. The display driving method as claimed in claim 1, wherein calculating a difference value of display data of at least one row in a display image of a current frame relative to display data of a corresponding row in a display image of a previous frame comprises:
calculating a difference value of display data of at least one row in a display image of a current frame relative to display data of a corresponding row in a display image of a previous frame using a binary system.

3. The display driving method as claimed in claim 1, wherein loading a gate scanning signal onto a gate line electrically connected with a pixel unit corresponding to each row in the display image of the current frame comprises:
loading a gate scanning signal onto the gate line twice successively.

4. The display driving method as claimed in claim 1, wherein increasing or decreasing a gray scale voltage corresponding to the difference value on a gray scale voltage corresponding to the display data of a corresponding row in the display image of the previous frame and outputting the obtained gray scale voltage to a respective data line comprise:
increasing or decreasing a gray scale voltage corresponding to the difference value on a gray scale voltage corresponding to the display data of a corresponding row in the display image of the previous frame and outputting the obtained gray scale voltage to a respective data line under control of a polarity reversal input signal, a latch input signal and a difference polarity input signal.

5. The display driving method as claimed in claim 4, wherein increasing or decreasing a gray scale voltage corresponding to the difference value on a gray scale voltage corresponding to the display data of a corresponding row in the display image of the previous frame and outputting the obtained gray scale voltage to a respective data line under control of a polarity reversal input signal, a latch input signal and a difference polarity input signal comprises:
when the calculated difference value is larger than zero, a polarity of the difference polarity input signal being positive, increasing a gray scale voltage corresponding to the difference value on a gray scale voltage corresponding to the display data of a corresponding row in the display image of the previous frame and outputting the obtained gray scale voltage to a respective data line under control of a polarity reversal input signal and a latch input signal; and
when the calculated difference value is smaller than zero, a polraity of the difference polarity input signal being negative, decreasing a gray scale voltage corresponding to the difference value on a gray scale voltage corresponding to the display data of a corresponding row in the display image of the previous frame and outputting the obtained gray scale voltage to a respective data line under control of a polarity reversal input signal and a latch input signal.

6. A display driving circuit of a display panel, comprising: a timing control circuit, a gate driving circuit and a source driving circuit; wherein,
the timing control circuit is used for calculating a difference value of display data of at least one row in a display image of a current frame relative to display data of a corresponding row in a display image of a previous frame;
the gate driving circuit is used for loading a gate scanning signal onto each gate line; and
the source driving circuit is used for converting difference values that are larger than zero and smaller than zero in the calculated difference values, as well as display data of rows in the display image of the current frame for which difference values are not calculated into gray scale voltages, wherein when a gate scanning signal is loaded onto a gate line electrically connected with a pixel unit corresponding to a row in the display image of the current frame for which a difference value is calculated, increasing or decreasing a gray scale voltage corresponding to the difference value on a gray scale voltage corresponding to the display data of a corresponding row in the display image of the previous frame and outputting the obtained gray scale voltage to a respective data line; and when a gate scanning signal is loaded onto a gate line electrically connected with a pixel unit corresponding to a row in the display image of the current frame for which the difference value is not calculated, outputting a gray scale voltage corresponding to the display data of the row in the display image of the current frame for which the difference value is not calculated to a respective data line.

7. The display driving circuit as claimed in claim 6, wherein the timing control circuit is used for calculating a difference value of display data of at least one row in a display image of a current frame relative to display data of a corresponding row in a display image of a previous frame using a binary system.

8. The display driving circuit as claimed in claim 6, wherein the gate driving circuit is used for loading a gate scanning signal onto a gate line electrically connected with a pixel unit corresponding to each row in the display image of the current frame twice successively.

9. The display driving circuit as claimed in claim 6, wherein the source driving circuit is used for increasing or decreasing a gray scale voltage corresponding to the difference value on a gray scale voltage corresponding to the display data of a corresponding row in the display image of the previous frame and outputting the obtained gray scale voltage to a respective data line under control of a polarity reversal input signal, a latch input signal and a difference polarity input signal.

10. The display driving circuit as claimed in claim 9, wherein the source driving circuit is used for: when the calculated difference value is larger than zero, a polarity of the difference polarity input signal being positive, increasing a gray scale voltage corresponding to the difference value on a gray scale voltage corresponding to the display data of a corresponding row in the display image of the previous frame and outputting the obtained gray scale voltage to a respective data line under control of a polarity reversal input signal and a latch input signal; and when the calculated difference value is smaller than zero, a polarity of the difference polarity input signal being negative, decreasing a gray scale voltage corresponding to the difference value on a gray scale voltage corresponding to the display data of a corresponding row in the display image of the previous frame and outputting the obtained gray scale voltage to a respective data line under control of a polarity reversal input signal and a latch input signal.

11. A display device, comprising: a display driving circuit as claimed in claim 6.

12. The display device as claimed in claim 11, wherein the timing control circuit is used for calculating a difference value of display data of at least one row in a display image of a current frame relative to display data of a corresponding row in a display image of a previous frame using a binary system.

13. The display device as claimed in claim 11, wherein the gate driving circuit is used for loading a gate scanning signal onto a gate line electrically connected with a pixel unit corresponding to each row in the display image of the current frame twice successively.

14. The display device as claimed in claim 11, wherein the source driving circuit is used for increasing or decreasing a gray scale voltage corresponding to the difference value on a gray scale voltage corresponding to the display data of a corresponding row in the display image of the previous frame and outputting the obtained gray scale voltage to a respective data line under control of a polarity reversal input signal, a latch input signal and a difference polarity input signal.

15. The display device as claimed in claim 14, wherein the source driving circuit is used for: when the calculated difference value is larger than zero, a polarity of the difference polarity input signal being positive, increasing a gray scale voltage corresponding to the difference value on a gray scale voltage corresponding to the display data of a corresponding row in the display image of the previous frame and outputting the obtained gray scale voltage to a respective data line under control of a polarity reversal input signal and a latch input signal; and when the calculated difference value is smaller than zero, a polarity of the difference polarity input signal being negative, decreasing a gray scale voltage corresponding to the difference value on a gray scale voltage corresponding to the display data of a corresponding row in the display image of the previous frame and outputting the obtained gray scale voltage to a respective data line under control of a polarity reversal input signal and a latch input signal.
